(19) United States
(12) Patent Application Publication
(10) Pub. No.: US 2005/0214632 A1
(43) Pub. Date: Sep. 29, 2005

(54) Membrane electrode assembly and proton exchange membrane fuel cell

(75) Inventors: Masahiro Kida, Nagoya-shi (JP); Satoshi Oowada, Obu-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 11/080,649

(22) Filed: Mar. 16, 2005

(30) Foreign Application Priority Data
Mar. 24, 2004 (JP) 2004-087552

(51) Int. Cl. H01M 4/94; H01M 8/10

(52) U.S. Cl. 429/44; 429/42; 429/30; 429/33

(57) ABSTRACT

A membrane electrode assembly comprises a gas diffusion layer for fuel to which fuel is supplied, a catalyst layer for fuel, which includes a catalyst, a electrically conductive material and an electrolyte material, an electrolyte membrane having ionic conductivity, a catalyst layer for oxidants, which includes a catalyst, a electrically conductive material and an electrolyte material, a gas diffusion layer for oxidants to which oxidizer gas is supplied, and these elements are sequentially positioned in that order, wherein the electrolyte material of the catalyst layer for fuel includes a larger amount per unit weight of a hydrocarbon electrolyte than an amount per unit weight of an electrolyte element of the catalyst layer for oxidants, and the electrolyte material of the catalyst layer for oxidants includes a larger amount per unit weight of a fluorocarbon electrolyte than an amount per unit weight of an electrolyte element of the catalyst layer for fuel.

This application is based on and claims priority under 35 U.S.C. § 119 to Japanese Patent Application 2004-087552, filed on Mar. 24, 2004, the entire content of which is incorporated herein by reference.

### FIELD OF THE INVENTION

The present invention generally relates to a membrane electrode assembly and a proton exchange membrane fuel cell that result in low costs and that produce both a satisfactory level of output voltage and a durability.

### BACKGROUND

A known electrolyte element used for a proton exchange membrane fuel cell generally includes a perfluorinated electrolyte element, which is classified in a carbon fluorine series and as represented by Nafion.

Such the perfluorinated electrolyte element generally excels at chemical stability and oxidation resistance, however, such material is known as an expensive material because the material includes a fluorine as a basic component and being synthesized through complex processes. This is why the proton exchange membrane fuel cell is prevented from being widely used (JPH03-208260A).

On the other hand, another type of the proton exchange membrane fuel cell, which uses a hydrocarbon electrolyte material, has been developed recently.

Such the hydrocarbon electrolyte material has an advantage in cost, however, it is generally known that the durability of such material is not enough.

Further, using a chelate functional group, an electrolyte material, whose durability is enhanced, has been developed recently (JP2001-223015).

In this circumstance, it has been longed for that a membrane electrode assembly and a proton exchange membrane fuel cell, which achieve low-cost, enough output voltage and enough durability, has been developed.

Thus, a need exist for a membrane electrode assembly and a proton exchange membrane fuel cell to achieves low costs and a satisfactory level of output voltage and durability.

### SUMMARY OF THE INVENTION

According to an aspect of the present invention, a membrane electrode assembly comprises a gas diffusion layer for fuel to which fuel is supplied, a catalyst layer for fuel, which catalyst layer includes a catalyst, a electrolyte electrically conductive material and an electrolyte material, an electrolyte membrane having ionic conductivity, a catalyst layer for oxidants, which catalyst layer includes a catalyst, a electrically conductive material and an electrolyte material, a gas diffusion layer for oxidants to which oxidizer gas is supplied, the gas diffusion layer for fuel, the catalyst layer for fuel, the electrolyte membrane, the catalyst layer for oxidants and the gas diffusion layer for oxidants being sequentially positioned in that order, wherein the electrolyte material of the catalyst layer for fuel includes a larger amount per unit weight of a hydrocarbon electrolyte than that in the electrolyte material of the catalyst layer for oxidants, and the electrolyte material of the catalyst layer for oxidants includes a larger amount per unit weight of a fluolelectrolyte element of a carbon fluorine series than that in the electrolyte material of the catalyst layer for fuel.

According to an aspect of the present invention, a proton exchange membrane fuel cell comprises a fuel distribution plate to which fuel is supplied, a gas diffusion layer for fuel to which the fuel is supplied from the fuel distribution plate, a catalyst layer for fuel, which catalyst layer includes a catalyst and a electrically conductive material, a electrolyte membrane having ionic conductivity,

a catalyst layer for oxidants, which catalyst layer includes a catalyst and a electrically conductive material, a gas diffusion layer for oxidants to which gas diffusion layer oxidizer gas is supplied, an oxidant distribution plate for supplying oxidizer gas to the gas diffusion layer for oxidants, the fuel distribution plate, the gas diffusion layer for fuel, the catalyst layer for fuel, the electrolyte membrane, the catalyst layer for oxidants, the gas diffusion layer for oxidants and the oxidant distribution plate being sequentially positioned in that order, wherein the electrolyte material of the catalyst layer for fuel includes a larger amount per unit weight of a hydrocarbon electrolyte than that in the electrolyte material of the catalyst layer for oxidants, and the electrolyte material of the catalyst layer for oxidants includes a larger amount per unit weight of a fluorocarbon electrolyte than that in the electrolyte material of the catalyst layer for fuel.

### BRIEF DESCRIPTION OF THE DRAWINGS

The foregoing and additional features and characteristics of the present invention will become more apparent from the following detailed description considered with reference to the accompanying drawings, wherein:

FIG. 1 illustrates a cross section that indicates a conceptual image before a membrane electrode assembly is formed;

FIG. 2 illustrates a cross section that indicates a conceptual image after the membrane electrode assembly is formed;

FIG. 3 illustrates a cross section that indicates a conceptual image in which a fuel distribution plate and an oxidizer gas distribution plate are positioned at the membrane electrode assembly;

FIG. 4 illustrates a graph that indicates test results of cell performance, and

FIG. 5 illustrates a graph that indicates test results of durability.

### DETAILED DESCRIPTION

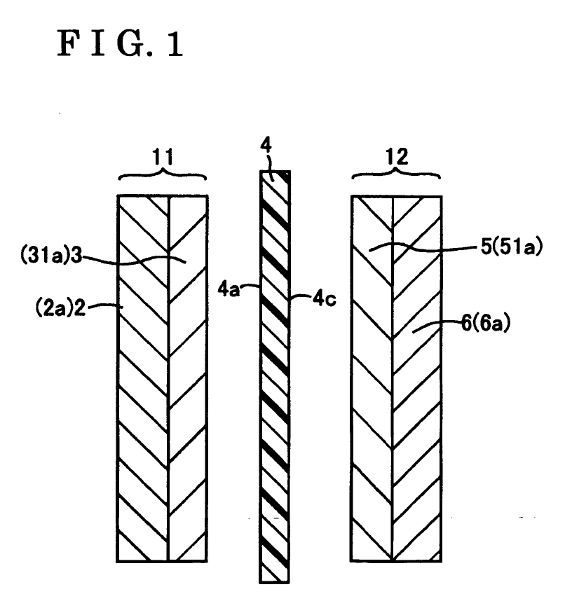

A preferred embodiment related to the present invention will be explained below with reference to the attached drawings FIGS. 1 through 5. In this embodiment, an electrolyte material of a catalyst layer for fuel on anode side includes a hydrocarbon electrolyte as a major component, and electrolyte material of a catalyst layer for oxidants on cathode side includes a fluorocarbon electrolyte as a major component. Specifically, the aforementioned “a major component” means that each the catalyst layer includes 50% or more of the electrolyte. Further, it is preferable that the catalyst layer includes 60% or more; or 70% or more of the electrolyte.

Thus, the electrolyte material of the catalyst layer for fuel on anode side is composed of a hydrocarbon electrolyte polymer, and the electrolyte material of the catalyst layer for oxidants on cathode side is composed of a fluorocarbon electrolyte polymer.

The hydrocarbon electrolyte polymer includes a principal chain in which carbon and hydrogen are bond together, and further includes fluorine-containing carbon hydride that contains a principal chain in which carbon and hydrogen are bond together, and a part of hydrogen is displaced by fluorine. Thus, in a chemical structure formula, when a total amount of a CH group, a CH₂ group, a CF group and a CF₂ group, which comprise the principal chain, is indicated in terms of percentage, a total amount of the CH group and the CH₂ group, which comprise the principal chain of the hydrocarbon electrolyte polymer, is be set between 40% or more and 100%. More preferably, the total amount of the CH group and the CH₂ group is set between 50% or more and 100%, or between 60% or more and 100%. Thus, in the embodiment, even when the aforementioned percentage is fulfilled, the hydrocarbon electrolyte polymer may include a copolymer, which includes a vinyl group-containing hydrocarbon monomer and a vinyl group-containing fluorocarbon monomer.

Preferably, the hydrocarbon electrolyte polymer is formed based on a copolymerised compound, in which a vinyl group-containing monomer is polymerized, and thus the hydrocarbon electrolyte polymer includes an ion-exchange group. The polymerised compound of the vinyl group-containing monomer is generally synthesized by polymerizing a radical polymerization, an ion polymerization or the like. Such the compound can be manufactured at a very low cost. To apply proton conductivity to the hydrocarbon polymer, in which the vinyl group-containing monomer is polymerized, the vinyl group-containing monomer that has one of the ion-exchange groups (e.g. a sulfonicacid group, a carboxylicacid group or a phosphinicacid group) is copolymerized, or the ion-exchange group is adapted to the polymer by a polymer reaction after the polymerization.

Thus, the hydrocarbon electrolyte polymer can be composed by sulfonating the electrolyte polymer, which is obtained by polymerizing the vinyl group-containing monomer. The vinyl group-containing monomer includes a chemical compound having the vinyl group and a polymerisation characteristic. Any vinyl group-containing monomer may be used if that performs a radical polymerization and an ion polymerization. A preferable example of the vinyl group-containing monomer will be explained as follow.

(Vinyl Group-Containing Monomer Having an Aromatic Ring)

The Vinyl group-containing monomer having an aromatic ring includes styrene, α-methylstyrene, methylstyrene, divinylbenzene, chloromethylstyrene, benzyl methacrylate, styrenesulfonic acid and p-styryltrimethoxysilane. One of the above monomers can be used. It is preferable that the monomer can be easily sulfonated, and that the monomer includes the sulfone at 10 mol % or more.

(Preferable Vinyl Group-Containing Monomer Which can Copolymerization)

The vinyl group-containing monomer includes acrylic acid, methacrylic acid, itaconic acid, maleic acid, succinate, phthalic acid, acrylic nitrile, vinyl acetate, trimethoxyvinylsilane, triethoxyvinylsilane, triethoxysopropylsilane, 2-acrylamide 2-methylpropanesulfonicacid or the like. One of above monomers can be used.

(Other Vinyl Group-Containing Monomer Which can Copolymerization)

A vinyl group-containing monomer including an ester derivative of acrylic acid or an ester derivative of methacrylic acid can be appropriately used. Such the monomer has a limitation on durability because it can be hydrolyzed. However, the durability can be prevented from being reduced depending on its purpose of usage. The monomer is randomly mixed so as to polymerize them by means of a radical polymerization and an ion polymerization, as a result, the hydrocarbon electrolyte polymer is composed.

It is preferable that the molecular weight of the hydrocarbon electrolyte polymer is set between 10,000 and 1,000,000. It is more preferable that the molecular weight of the hydrocarbon electrolyte polymer is set between 30,000 and 200,000. When the molecular weight is small, the electrolyte polymer has poor chemical stability and has a limitation on its durability. When the molecular weight is large, the electrolyte polymer has poor solubility.

The hydrocarbon electrolyte has not enough water repellency comparing to the water repellency of the fluorocarbon electrolyte. Thus, the water-repellent area is reduced, and then a water-flooding occurs on the high-current density side so as to increase the frequency that the path for gas is blocked. Thus, the hydrocarbon electrolyte is not used for an electrolyte material of the catalyst layer for oxidants on a cathode side, at which the water-flooding frequently occurs, and the hydrocarbon electrolyte is used for an electrolyte material of the catalyst layer for fuel on an anode side, at which the water-flooding rarely occurs. Such configuration can decrease the cost and prevent the flooding so as to secure the power-generating performance.

(A Fluorocarbon Electrolyte)

A fluorocarbon electrolyte polymer, which includes an electrolyte element of the above carbon fluorine series, can be used. Specifically, as a fluorocarbon electrolyte material is formed based on a polymer that includes one of the following materials, or that includes a copolymer of the following materials: perfluoroethylvinylether; perfluoropropylvinylether; tetrafluoroethylene; hexafluoropropylene; vinylidenefluorochloride; trifluoroethylenechloride; vinylfluororide and 2-bromo-1,1,2,2-tetrafluoroethyltrifluorovinylether. The fluorocarbon electrolyte material includes an ion-exchange group such as a sulfonic acid group, carboxylic acid group, phosphinic acid group or the like. It is preferable that the molecular weight of the fluorocarbon electrolyte polymer is set between 10,000 and 1,000,000. It is more preferable that the molecular weight of the fluorocarbon electrolyte polymer is set between 30,000 and 200,000.

The fluorocarbon electrolyte polymer includes a principal chain, in which the carbon and fluorine are bonded, however, the fluorocarbon electrolyte polymer may also includes a principal chain, in which carbon and fluorine are bonded, and a part of fluorine is replaced to the carbon and fluorine, specifically, the electrolyte polymer may includes hydrogen-containing carbon fluorine. Thus, in a chemical structure formula, when a total amount of a CF group, a CF₂ group, a CH group and a CH₂ group, which comprise the principal chain, is indicated in terms of percentage, a total amount of the CH group and the CH₂ group, which comprise the principal chain of the fluorocarbon electrolyte polymer, is set between 40% or more and 100%. More preferably, the total amount of the CF group and the CF₂ group is set between more than 70% and 100%, or between 80% or more and 100%.

(Ion-Exchange Group)

An ion-exchange group can be adopted to the hydrocarbon electrolyte and the fluorocarbon electrolyte. The type of the ion-exchange group is not limited unless it has proton conductivity. Further, a sulfonic acid group can be adopted by sulfonating, and furthermore, the ion-exchange group is adopted to the electrolyte element by chloresulfonating or phosphonating. Thus, the ion-exchange group includes a sulfonic acid, a chemical compound of a sulfonic acid group, a phosphinic acid chemical compound of a phosphinic acid, a group, carboxylic acid chemical compound of a carboxylic acid group. Considering the proton conductivity, it is preferable that the sulfonic acid group is used. The proton conductivity can be obtained from these materials so as to synthesize an intended proton conductivity material. The method for sulfonating is not limited, however, it is preferable that the hydrocarbon electrolyte polymer includes an aromatic ring.

To obtain appropriate proton conductivity, a required amount of the ion-exchange group such as a sufone group on the hydrocarbon electrolyte polymer is set between 0.2 meq/g and 8 meq/g, more preferably between 0.5 meq/g and 6 meq/g, still more preferably between 0.6 meq/g and 4 meq/g. An required amount of the ion-exchange group such as a sufone group on the fluorocarbon electrolyte polymer is set between 0.3 meq/g and 4 meq/g, more preferably between 0.4 meq/g between 3 meq/g, still more preferably between 0.6 meq/g and 2 meq/g. Such amounts have been set considering reliability on the durability and the fuel cell output performance. If the amount of the ion-exchange capacity is too large, solubility into water is enhanced, and improvement of reliability on the durability may be limited. On the other hand, if the amount of the ion-exchange capacity is too small, the proton electrically conductive speed is reduced, and the improvement on the fuel cell output performance may be limited.

The solubility of the electrolyte polymer depends on the composition of the elements of the electrolyte polymer. It is preferable that the electrolyte polymer may be completely dissolved into the electrolyte solution, however, the solution may be dispersed by means of a homogenizer or the like so as to prepare a slurrying-dispersion liquid. It is preferable that the electrolyte polymer to be dissolved into the electrolyte solution is shattered so as to be changed in size into a small particle, more preferably, the size of the electrolyte polymer is 20 μm and below, further 10 μm and below, furthermore 5 μm and below. The method for preparing the solution or for dispersing the solution are not limited. Any fluid medium (solvent, disperse medium) can be used depending on the element of the electrolyte polymer. Specifically, as a fluid medium, one of the following alcohol-series medium, such as H₂O, ethanol, methanol, 1-propanol, 2-propanol or the like, or one of the following amine series solvent, such as dimethylformamide, dimethylacetamide, N-methylpyrrolidone or the like, can be used. In addition, as a fluid medium, one of the followings; xylene, toluene, acetic ether, butyl acetate, acetone, methyl ethyl ketone or the like can be used depending on the solubility of the electrolyte polymer.

A carbon microparticle can be adopted as a electrically conductive material included in the catalyst layer for fuel and the catalyst layer for oxidants, and a carbon black (including an acethyne black and a ketjen black), an activated carbon, a graphite or the like can be used as the carbon microparticle. As a catalyst included in the catalyst layer for fuel and the catalyst layer for oxidants, at least one of the following; platinum, palladium, rhodium, iridium and ruthenium can be adopted. As a carbon supported catalyst microparticle, a carbon supported platinum microparticle (hereinbelow referred to as carbon supported platinum) can be adopted.

(Electrolyte Membrane)

An electrolyte membrane is composed of a hydrocarbon electrolyte polymer, or a fluorocarbon electrolyte polymer. The electrolyte membrane may be composed of an electrolyte polymer, which is a hydrocarbon copolymer and a carbon fluorine series. In this case, the electrolyte membrane may also be composed of a hydrocarbon copolymer-vinyl group-containing monomer and carbon fluorine series-vinyl group-containing monomer. It is preferable that the electrolyte membrane includes an ion-exchange group (sulfonic acid group, carboxylic acid group, phosphinic acid group or the like). The hydrocarbon, the carbon fluorine series and the ion-exchange group have been already explained in the above section where the electrolyte element of the catalyst layer is explained.

(Membrane Electrode Assembly Manufacturing)

In a process of a membrane electrode assembly manufacturing, a fluid such as a slurry is applied to a porous base material that composes a gas diffusion layer. Alternatively, a fluid such as the slurry may be applied to a surface of the electrolyte membrane that has ionic conductivity. Then, the diffusion layer and the electrolyte membrane are integrally bonded by pressing at a predetermined pressure (e.g. 0.5-20 MPa) under a predetermined temperature (e.g. 100° C.-140° C.). It is preferable that a hot-pressing method is used in the pressing process. Alternatively, the diffusion layer and the electrolyte membrane may be integrally bonded by pressing under a room temperature range. A carbon paper or a carbon cloth, to which water repellent material is impregnated, can be used as the porous base material.

The embodiment of the present invention will be explained more specifically.

(Manufacturing a Hydrocarbon Electrolyte Polymer Having Ionic Conductivity)

In an acrylate resin made-reaction vessel, in which a nitrogen replacing equipment, an agitator, temperature indicator, a reflux cooling device and a heating device, are provided, xylene (solution) 200 cc is set so as to be heated at 90° C. and agitated. Then, 100 cc of styrenemonomer, 100 cc of acrylic nitrile monomer, and 0.2 g of benzoyl peroxide (polymerization initiator) have been dropped for three hours into the xylene so as to compose a solution. The solution has been maintained for one hour at 90° C., and then cooled down to a room temperature. This solution is dropped into a large amount of methanol so as to generate a polymer (polystyrene-acrylic nitrile copolymer). The polymer is crystallized and filtered. The filtered polymer has been dried for an hour at 90° C. so as to generate a dried-powder type-carbon polymer of a hydride series.

In a flask, which is capable of measuring 1000 cc of liquid, 150 g of the polymer, which is synthesize in the above process, is dissolved into 500 cc of 1,2-dichloroethane. While the solution has been heated at 60° C. and agitated, 30 cc of a chlorosulfonic acid has been dropped in the flask. Then, the solution has been heated at 60° C. and maintained for an hour so as to sulfonate. Thus, a chlorosulfonated electrolyte polymer (polystyrene-acrylic nitrile copolymer) can be obtained. The chlorosulfonated electrolyte polymer is rinsed with 1, 2 dichloroethane and filtered so as to obtain an electrolyte polymer.

The electrolyte polymer (polyethylene-acrylic nitrile copolymer) has been agitated in ion-exchange water for three hours at 90° C., and then, the agitated electrolyte polymer is rinsed and filtered. Then, the filtered sulfonated electrolyte polymer (polyethylene-acrylic nitrile copolymer) is heated and air-dried for an hour at 105° C. so as to obtain an electrolyte polymer. At this point, the molecular weight (Mw) of the electrolyte polymer is 100,000, and the ion-exchange capacity (IEC) of the electrolyte polymer is 1.94 (meq/g).

The weight-average molecular weight is measured by Gel Permeation Chromatography (GPC) as a molecular weight. The ion-exchange capacity (IEC) is measured as followed. First, 0.05 g of a test sample material is weighed by means of a precision balance and put into a beaker whose capacity is 100 ml. The weighed test sample material is dissolved into 20 cc of ethanol so as to compose a solution. Then, a drop of phenolphthalein (or appropriate amount of phenolphthalein) as an indicator is dropped into the solution. 0.05 mol/L of the sodium hydroxide solution is titrated by means of a buret into the solution. If the phenolphthalein in the solution reacts to the sodium hydroxide solution, it changes color into red. Set end point After the solution is maintained for few seconds, and the ion-exchange capacity is calculated from the following formula using the amount of the titer.
ion-exchange capacity=(0.05*titer ml)/(sample material amount g)

(Composing a Hydrocarbon Electrolyte Solution Having Ionic Conductivity)

10 g hydrocarbon-electrolyte polymer, which is sulfonated in the above process, is dissolved into 190 g of a mixed solution, in which the ion-exchange water and ethanol are mixed at volume ratio 1:1, so as to form a hydrocarbon-electrolyte solution (5 wt %).

(Forming a Paste-Type Catalyst for a Catalyst Layer for Fuel)

20 g of a carbon supported platinum (platinum amount 50 wt %) is put into 100 g hydrocarbon-electrolyte solution. The carbon supported platinum includes a carbon microparticle as a electrically conductive material, and platinum as a catalyst, wherein the platinum is supported by the carbon microparticle. 76 g of ion-exchange water and 45 g of isopropyl alcohol are poured into the solution so as to be agitated. Then, beads (beads-type zirconia, 2 mm in diameter) are put into the solution, and the solution is mixed and dispersed by means of a high-speed homogenizer so as to form a microparticle of carbon supported platinum, whose average particle size is 0.1-1.0 μm. Thus, the paste-type catalyst for the catalyst layer for fuel can be obtained. An average particle diameter means a mode diameter on the basis of a particle diameter distribution map.

Generally, a hydrocarbon electrolyte polymer has an enough dispersibility comparing to that of the fluorocarbon electrolyte polymer, so that the average particle diameter of the carbon supported platinum, which can be easily agglutinate, can be decreased.

(Forming a Paste-Type Catalyst for a Catalyst Layer for Oxidants)

A electrolyte solution containing a commercially available electrolyte polymer perfluorinated (5 wt % of Nafion solution: manufactured by Aldrich) is used as a fluorocarbon electrolyte solution. Specifically, the perfluorinated electrolyte polymer includes Nafion 117 manufactured by Du Pont. The ion-exchange capacity (IEC) of this electrolyte polymer is 0.909 (meq/g).

20 g of a carbon supported platinum (platinum amount 50 wt %) is put into 100 g of the perfluorinated-electrolyte solution. 76 g of ion-exchange water and 45 g of isopropyl alcohol are poured into the solution so as to be agitated. Then, beads (beads-type zirconia, 2 mm in diameter) are put into the solution, and the solution is mixed and dispersed by means of a high-speed homogenizer so as to form a microparticle of carbon supported platinum, whose average particle size is 0.1-1.0 μm. Thus, the paste-type catalyst for the catalyst layer for fuel can be obtained.

(Manufacturing the Membrane Electrode Assembly)

A porous base material 2a (thickness: 180 μm, porosity: 65 volume %) is prepared by applying water-repellent process to a carbon paper. As shown in FIG. 1, on one surface of the porous base material 2a, a paste type-catalyst 31a for a fuel catalyst is applied by means of a bar-coater. At this point, the amount of the supported platinum in the carbon supported platinum is 1.0 mg/cm2. After the paste type-catalyst 31a is applied to the surface of the porous base material 2a, the paste type-catalyst 31a is heat-dried for a half hour under 80° C. so as to form a catalyst layer for fuel 3. Thus, an anode 11, which includes a catalyst layer for fuel 3 and a gas diffusion layer for fuel 2, is prepared.

A porous base material 6a (thickness: 180 μm, porosity: 65 volume %) is prepared by applying water-repellent process to a carbon paper. As shown in FIG. 1, on one surface of the porous base material 6a, a paste type-catalyst 51a for an oxidant catalyst is applied by means of a bar-coater. At this point, the amount of the supported platinum in the carbon supported platinum is 1.0 mg/cm2. After the paste type-catalyst 51a is applied to the surface of the porous base material 6a, the paste type-catalyst 51a is heat-dried for a half hour under 80° C. so as to form a catalyst layer for oxidants 5. Thus, a cathode 12, which includes a catalyst layer for oxidants 5 and a gas diffusion layer for oxidants 6, is prepared.

As shown in FIG. 1, the electrolyte membrane 4 is sandwiched between the anode 11 and the cathode 12, in which the catalyst layer for fuel 3 of the anode 11 faces a surface 4a, which is one surface of the electrolyte membrane 4, and the catalyst layer for oxidants 5 of the cathode 12 faces a surface 4c, which is the other surface of the electrolyte membrane 4, and then the electrolyte membrane 4 is sandwiched between the anode 11 and the cathode 12 is pressed by means of a hot-pressing machine under 120° C. at 5 MPa for three minutes so as to form the membrane electrode assembly 1.

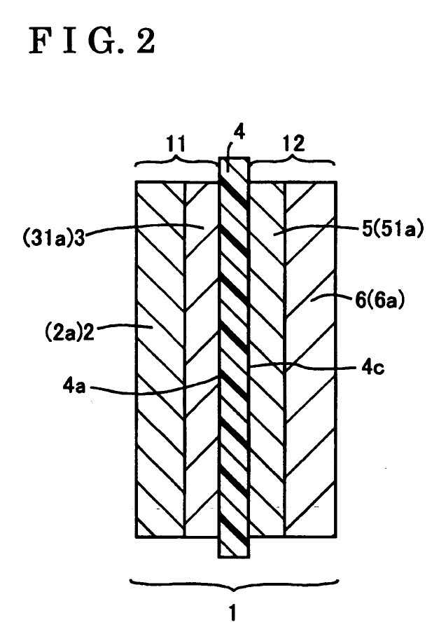

Specifically, as shown in FIG. 2, the membrane electrode assembly 1 includes the gas diffusion layer for fuel 2 having porous and conductivity, to which fuel is applied, the catalyst layer for fuel 3 including a catalyst, a electrically conductive material and an electrolyte polymer, the electrolyte membrane 4 having ionic conductivity (proton conductivity), the catalyst layer for oxidants 5 including a catalyst, a electrically conductive material and an electrolyte polymer, the gas diffusion layer for oxidants 6 having porous and conductivity, to which oxidizer gas is applied, and the gas diffusion layer for fuel 2, the catalyst layer for fuel 3, the electrolyte membrane 4, the catalyst layer for oxidants 5, the gas diffusion layer for oxidants 5 are sequentially positioned in that order.

As mentioned above, according to the present embodiment, durability of the catalyst layer for oxidants 5 of the cathode 12, at which the hydrogen peroxide solution is frequently generated, is composed of the perfluoro series-electrolyte polymer, which is a carbon fluorine series having a high chemical stability, so that the durability of the catalyst layer for oxidants 5 is secured. On the other hand, the catalyst layer for fuel 3 of the anode 11, at which the hydrogen peroxide solution rarely generated, is composed of the electrolyte polymer, which is a hydrocarbon having an advantage on the cost, so that the durability of the catalyst layer for fuel 3 can be enhanced, and the cost can be reduced.

(Test Results)

The cell performance and the durability on a test fuel cell, in which the membrane electrode assembly 1 is assembled in a single cell, has been tested.

Conditions of the test is as follow;

Electrode area is 9 cm2.
Temperature in the cell is 77° C.
Hydrogen gas is used as fuel.
Oxygen gas is used as oxidizer gas.
Humidification mole ratio is hydrogen gas/oxygen gas=0.2 mole/0.15 mole.
Usage ratio of hydrogen gas is 85%.
Usage ratio of oxygen is 40%.

The same tests have been executed on comparative embodiments 1 and 2 under the above conditions. The comparative embodiment 1 basically has similar configuration to the present embodiment, however, the fluorocarbon electrolyte polymer, which is used for the catalyst layer for oxidants 5 in the present embodiment, is used at both the catalyst layer for fuel on anode side and the catalyst layer for oxidants on cathode side. In addition, the comparative embodiment 2 basically has similar configuration to the present embodiment, however, the electrolyte polymer of, which is used for the catalyst layer for fuel 3 in the present embodiment, is used at both the catalyst layer for fuel on anode side and the catalyst layer for oxidants on cathode side.

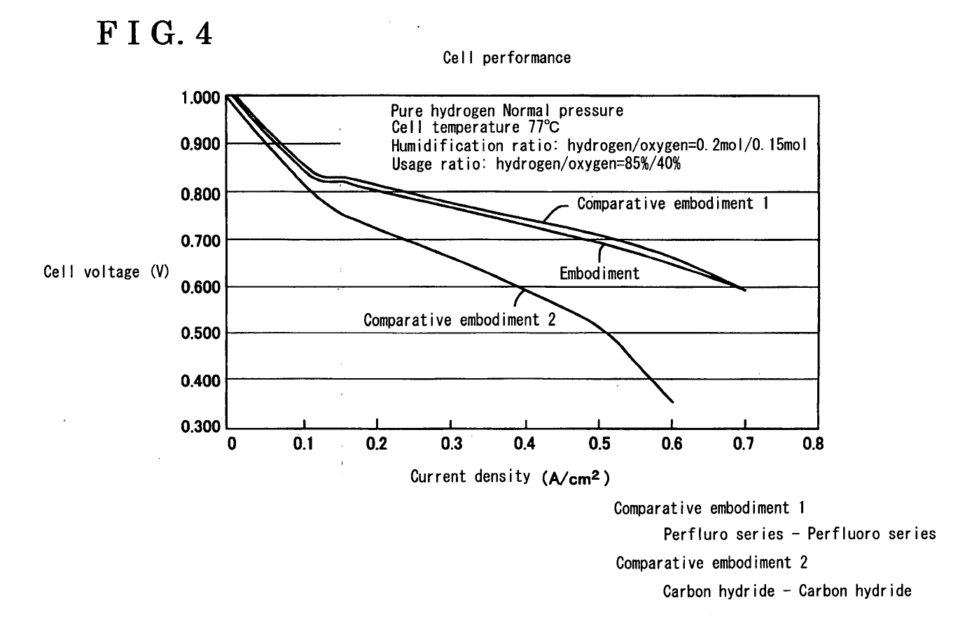

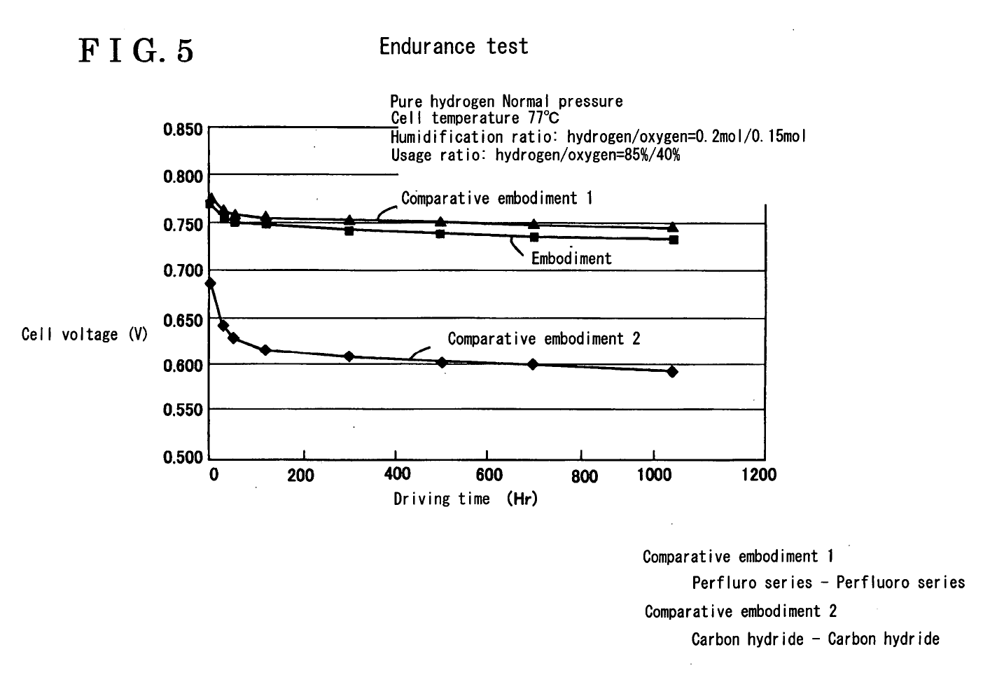

FIG. 4 indicates test results of the cell performance. A horizontal axis in FIG. 4 indicates a current density, and a vertical axis in FIG. 4 indicates a cell electric pressure. FIG. 5 indicates test results of the durability. A horizontal axis in FIG. 5 indicates a driving time, and vertical axis in FIG. 5 indicates a cell electric pressure. The embodiment has an advantage in the durability.

As shown in FIG. 4 and FIG. 5, the comparative embodiment 1, which uses an electrolyte material perfluorinated in both the catalyst layer for fuel and the catalyst layer for oxidants, has the best results in the cell performance and the durability, however, the comparative embodiment 1 has a disadvantage in cost.

The comparative embodiment 2, which uses a hydrocarbon electrolyte material in both the catalyst layer for fuel and the catalyst layer for oxidants, has poor results in both the cell performance and the durability. On the other hand, the present embodiment has good results in the cell performance and the durability, which almost equals to the results of the comparative embodiment 1. Further, according to the present embodiment, the catalyst layer for oxidants 5 on cathode side is made of the electrolyte polymer in the perfluoro series, which has high chemical stability, however, catalyst layer for fuel 3 on anode side is made of hydrocarbon electrolyte polymer, which has an advantage in cost, so that the catalyst layer for fuel 3 has an advantage in cost in comparison with comparative embodiment 1.

(Application Example)

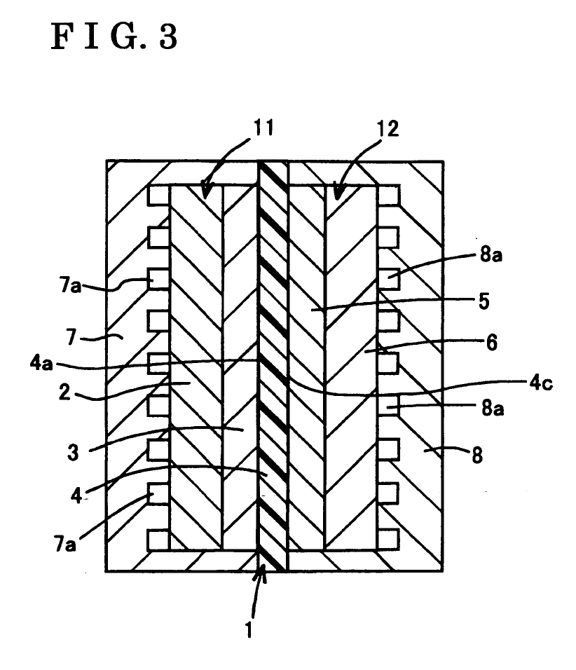

FIG. 3 indicate a schematic diagram of an application example. As shown in FIG. 3, a proton exchange membrane fuel cell includes; a fuel distribution plate 7 having conductivity and including a path 7a to which fuel is supplied, the gas diffusion layer for fuel 2 to which the gas-type fuel (e.g. hydrogen gas, hydrogen-containing gas) is supplied from the path 7a of the fuel distribution plate 7, the catalyst layer for fuel 3 including a catalyst (platinum), a electrically conductive material (carbon) and an electrolyte material, the electrolyte membrane 4 having ionic conductivity, the catalyst layer for oxidants 5 including a catalyst (platinum), a electrically conductive material (carbon) and an electrolyte material, the gas diffusion layer for oxidants 6 to which the oxidizer gas (e.g. oxygen gas, oxygen-containing gas) is supplied, and an oxidant distribution plate 8 having conductivity and including a path 8a for supplying oxidizer gas to the gas diffusion layer for oxidants 6, the fuel distribution plate 7, the gas diffusion layer for fuel 2, the catalyst layer for fuel 3, the electrolyte membrane 4, the catalyst layer for oxidants 5, the gas diffusion layer for oxidants 6 and the oxidant distribution plate 8 are sequentially positioned in that order.

The electrolyte material of the catalyst layer for fuel 3 on anode side includes a larger amount per unit weight of a hydrocarbon electrolyte than that in the electrolyte material of the catalyst layer for oxidants 5. Specifically, the electrolyte material of the catalyst layer for fuel 3 on anode side is composed of the hydrocarbon electrolyte polymer.

On the other hand, The electrolyte material of the catalyst layer for oxidants 5 on cathode side includes a larger amount per unit weight of a hydrocarbon electrolyte than that in the electrolyte material of catalyst layer for fuel 3. Specifically, the electrolyte material of the catalyst layer for oxidants 5 on cathode side is composed of the perfluorinated electrolyte polymer.

As mentioned above, according to the application example, durability of the catalyst layer for oxidants 5 of the cathode 12, at which the hydrogen peroxide solution is frequently generated, is composed of the perfluoro series-electrolyte polymer, which is a carbon fluorine series having a high chemical stability, so that the durability of the catalyst layer for oxidants 5 is secured.

On the other hand, the catalyst layer for fuel 3 of the anode 11, at which the hydrogen peroxide solution rarely generated, is composed of the hydrocarbon electrolyte polymer, which is a having an advantage on the cost, so that the durability of the catalyst layer for fuel 3 can be enhanced, and the cost can be reduced.

In the above embodiment, a perfluoro series membrane is used as the electrolyte membrane 4, however, a membrane which is composed of a ethylene-tetrafluoroethylene copolymer series may be used alternatively. This membrane is composed based on a copolymer of a vinyl group-containing hydrocarbon monomer and a vinyl group-containing fluorocarbon monomer. The electrolyte membrane 4 may includes an electrolyte membrane, which is composed based on the vinyl group-containing hydrocarbon monomer alternatively.

The electrolyte material included at the catalyst layer for fuel 3 on anode side may be composed based on an ethylene-tetrafluoroethylene copolymer. The present invention can be used for a fuel cell for a vehicle, a stationary usage, an electric device and an electronic device.

The inventor of this invention has been dedicated to develop a membrane electrode assembly and a proton exchange membrane fuel cell. Generally, in a power generating reaction of the proton exchange membrane fuel cell, hydrogen as fuel is separated into proton (H+) and electron (e−) at fuel electrode side, which is anode. The proton passes through the electrolyte membrane and reaches an oxidant electrode, which is cathode. At the oxidant electrode, the proton receives oxygen and electron so as to form water based on a formula 1.
2H⁺+1/2O₂+2e→H₂O Formula 1

In oxidant electrode, according to the power generating reaction, a small amount of hydrogen peroxide solution is further generated based on a formula 2.
2H⁺+O₂+2e⁻→H₂O₂ Formula 2

The hydrogen peroxide solution may cause degradation on the electrolyte material. The inventor of this invention focuses on a fact that the hydrogen peroxide solution cannot be easily generated on the fuel electrode of anode comparing to the oxidant electrode generated of cathode. The inventor of the present invention further detect a fact from a test, which a proton exchange membrane fuel cell can achieve enough output voltage and enough durability, yet being at low cost if an electrolyte material of the catalyst layer for fuel on anode side includes a large amount of the hydrocarbon electrolyte element, which has an advantage in cost, and an electrolyte material of the catalyst layer for oxidants on cathode side includes a large amount of the fluorocarbon electrolyte, which has high chemical stability.

Thus, a membrane electrode assembly according to the present invention comprises a gas diffusion layer for fuel to which fuel is supplied, a catalyst layer for fuel, which catalyst layer includes a catalyst, a electrically conductive material and an electrolyte material, an electrolyte membrane having ionic conductivity, a catalyst layer for oxidants, which catalyst layer includes a catalyst, a electrically conductive material and an electrolyte material, a gas diffusion layer for oxidants to which oxidizer gas is supplied, the gas diffusion layer for fuel, the catalyst layer for fuel, the electrolyte membrane, the catalyst layer for oxidants and the gas diffusion layer for oxidants being sequentially positioned in that order, wherein the electrolyte material of the catalyst layer for fuel includes a larger amount per unit weight of a hydrocarbon electrolyte than that in the electrolyte material of the catalyst layer for oxidants, and the electrolyte material of the catalyst layer for oxidants includes a larger amount per unit weight of a fluorocarbon electrolyte than that in the electrolyte material of the catalyst layer for fuel.

Further, a proton exchange membrane fuel cell according to the present invention comprises a fuel distribution plate to which fuel is supplied, a gas diffusion layer for fuel to which the fuel is supplied from the fuel distribution plate, a catalyst layer for fuel, which catalyst layer includes a catalyst and a electrically conductive material, a electrolyte membrane having ionic conductivity, a catalyst layer for oxidants, which catalyst layer includes a catalyst and a electrically conductive material, a gas diffusion layer for oxidants to which gas diffusion layer oxidizer gas is supplied, an oxidant distribution plate for supplying oxidizer gas to the gas diffusion layer for oxidants, the fuel distribution plate, the gas diffusion layer for fuel, the catalyst layer for fuel, the electrolyte membrane, the catalyst layer for oxidants, the gas diffusion layer for oxidants and the oxidant distribution plate being sequentially positioned in that order, wherein the electrolyte material of the catalyst layer for fuel includes a larger amount per unit weight of a hydrocarbon electrolyte than an amount per unit weight of an electrolyte element of the catalyst layer for oxidants, and the electrolyte material of the catalyst layer for oxidants includes a larger amount per unit weight of a fluorocarbon electrolyte than that in the electrolyte material of the catalyst layer for fuel.

Durability of the catalyst layer for oxidants on a cathode side, at which the hydrogen peroxide solution is frequently generated, includes a large amount of the fluorocarbon electrolyte polymer, which has a high chemical stability, so that the durability of the catalyst layer for oxidants is secured. On the other hand, the catalyst layer for fuel on a anode side, at which the hydrogen peroxide solution rarely generated, includes a large amount of the hydrocarbon electrolyte polymer, which has an advantage on the cost, so that the durability of the catalyst layer for fuel 3 can be enhanced, and the cost can be reduced.

In a chemical structure formula, the hydrocarbon electrolyte includes a principal chain, which is composed of a CH group and/or a CH₂ group and an ion-exchange group. In a chemical structure formula, the above fluorocarbon electrolyte includes a principal chain, which is composed of a CF group or/and a CF₂ group and ion-exchange group.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A membrane electrode assembly comprising:
a gas diffusion layer for fuel to which fuel is supplied,
a catalyst layer for fuel, which catalyst layer includes a catalyst, an
electrically conductive material and an electrolyte material,
an electrolyte membrane having ionic conductivity,
a catalyst layer for oxidants, which catalyst layer includes a catalyst, an electrically conductive material and an electrolyte material,
a gas diffusion layer for oxidants to which oxidizer gas is supplied,
the gas diffusion layer for fuel, the catalyst layer for fuel, the electrolyte membrane, the catalyst layer for oxidants and the gas diffusion layer for oxidants being sequentially positioned in that order,
wherein the electrolyte material of the catalyst layer for fuel includes a larger amount per unit weight of a hydrocarbon electrolyte than that in the electrolyte material of the catalyst layer for oxidants, and the electrolyte material of the catalyst layer for oxidants includes a larger amount per unit weight of a fluorocarbon electrolyte than that in the electrolyte material of the catalyst layer for fuel.

2. The membrane electrode assembly according to claim 1, wherein the electrolyte material of the catalyst layer for fuel includes a hydrocarbon electrolyte as a major component, and the electrolyte material of the catalyst layer for oxidants includes a fluorocarbon electrolyte as a major component.

3. The membrane electrode assembly according to claim 1, wherein the electrolyte material of the catalyst layer for fuel is composed of a hydrocarbon electrolyte polymer, and the electrolyte material of the catalyst layer for oxidants is composed of a fluorocarbon electrolyte polymer.

4. The membrane electrode assembly according to claim 3, wherein the hydrocarbon electrolyte polymer is an ionomer based on a copolymer in which a vinyl group-containing monomer is polymerized.

5. The membrane electrode assembly according to claim 4, wherein the copolymer that is a base material of the hydrocarbon electrolyte polymer is an ethylene-tetrafluoroethylene copolymer.

6. The membrane electrode assembly according to claim 4, wherein the vinyl group-containing monomer is one of the following: styrene, α-methylstyrene, methylstyrene, divinylbenzene, chloromethylstyrene, benzyl methacrylate, styrenesulfonic acid, p-styryltrimethoxysilane, acrylic acid, methacrylic acid, itaconic acid, maleic acid, succinate, phthalic acid, acrylic nitrile, vinyl acetate, trimethoxyvinylsilane, triethoxyvinylsilane, triethoxysopropylsilane, 2-acrylamide 2-methylpropanesulfonicacid, an ester derivative of acrylic acid or an ester derivative of methacrylic acid.

7. The membrane electrode assembly according to claim 3, wherein, when a total amount of a CH group, a CH₂ group, a CF group and a CF₂ group, which comprise a main chain of the hydrocarbon electrolyte polymer, is indicated in terms of percentage, a total amount of the CH group and the CH₂ group, which comprise the main chain of the hydrocarbon electrolyte polymer, is set between 40% and 100%.

8. The membrane electrode assembly according to claim 3, wherein, when a total amount of a CH group, a CH₂ group, a CF group and a CF₂ group, which comprise a main chain of the hydrocarbon electrolyte polymer, is indicated in terms of a percentage, a total amount of the CF group and the CF₂ group, which comprise the main chain of the fluorocarbon electrolyte polymer, is set between 70% and 100%.

9. The membrane electrode assembly according to claim 3, wherein the fluorocarbon electrolyte material is formed based on a ionomer that includes one of the following materials, or that includes a copolymer of the following materials: perfluoroethylvinylether; perfluoropropylvinylether; tetrafluoroethylene; hexafluoropropylene; vinylidenefluorochloride; trifluoroethylenechloride; vinylfluororide and 2-bromo-1, 1, 2, 2-tetrafluoroethyltrifluorovinylether.

10. The membrane electrode assembly according to claim 1, wherein the electrolyte membrane includes a perfluorinated membrane or a hydrocarbon membrane.

11. A proton exchange membrane fuel cell comprising;
a fuel distribution plate to which fuel is supplied,
a gas diffusion layer for fuel to which the fuel is supplied from the fuel distribution plate,
a catalyst layer for fuel, which catalyst layer includes a catalyst and a electrically conductive material,
a electrolyte membrane having ionic conductivity,
a catalyst layer for oxidants, which catalyst layer includes a catalyst and a electrically conductive material,
a gas diffusion layer for oxidants to which gas diffusion layer oxidizer gas is supplied,
an oxidant distribution plate for supplying oxidizer gas to the gas diffusion layer for oxidants,
the fuel distribution plate, the gas diffusion layer for fuel, the catalyst layer for fuel, the electrolyte membrane, the catalyst layer for oxidants, the gas diffusion layer for oxidants and the oxidant distribution plate being sequentially positioned in that order,
wherein the electrolyte material of the catalyst layer for fuel includes a larger amount per unit weight of an hydrocarbon electrolyte than that in the electrolyte material of the catalyst layer for oxidants, and the electrolyte material of the catalyst layer for oxidants includes a larger amount per unit weight of a fluorocarbon electrolyte than that in the electrolyte material of the catalyst layer for fuel.

12. The proton exchange membrane fuel cell according to claim 11, wherein the electrolyte material of the catalyst layer for fuel includes a hydrocarbon electrolyte as a major component, and the electrolyte material of the catalyst layer for oxidants includes a fluorocarbon electrolyte as a major component.

13. The proton exchange membrane fuel cell according to claim 11, wherein the electrolyte material of the catalyst layer for fuel is composed of a hydrocarbon electrolyte polymer, and the electrolyte material of the catalyst layer for oxidants is composed of a fluorocarbon electrolyte polymer.

14. The proton exchange membrane fuel cell according to claim 13, wherein the hydrocarbon electrolyte polymer is an ionomer based on a copolymer in which a vinyl group-containing monomer is polymerized.

15. The proton exchange membrane fuel cell according to claim 14, wherein the copolymer that is a base material of the hydrocarbon electrolyte polymer is an ethylene-tetrafluoroethylene copolymer.

16. The proton exchange membrane fuel cell according to claim 14, wherein the vinyl group-containing monomer is one of the following: styrene, α-methylstyrene, methylstyrene, divinylbenzene, chloromethylstyrene, benzyl methacrylate, styrenesulfonic acid, p-styryltrimethoxysilane, acrylic acid, methacrylic acid, itaconic acid, maleic acid, succinate, phthalic acid, acrylic nitrile, vinyl acetate, trimethoxyvinylsilane, triethoxyvinylsilane, triethoxysopropylsilane, 2-acrylamide 2-methylpropanesulfonicacid, an ester derivative of acrylic acid or an ester derivative of methacrylic acid.

17. The proton exchange membrane fuel cell according to claim 13, wherein, when a total amount of a CH group, a CH₂ group, a CF group and a CF₂ group, which comprise a main chain of the hydrocarbon electrolyte polymer, is indicated in terms of percentage, a total amount of the CH group and the CH₂ group, which comprise the main chain of the hydrocarbon electrolyte polymer, is set between 40% and 100%.

18. The proton exchange membrane fuel cell according to claim 13, wherein, when a total amount of a CH group, a CH₂ group, a CF group and a CF₂ group, which comprise a main chain of the fluorocarbon electrolyte polymer, is indicated in terms of a percentage, a total amount of the CF group and the CF₂ group, which comprise the main chain of the fluorocarbon electrolyte polymer, is set between 70% and 100%.

19. The proton exchange membrane fuel cell according to claim 13, wherein the fluorocarbon electrolyte material is formed based on a polymer that includes one of the following materials, or that includes a copolymer of the following materials: perfluoroethylvinylether; perfluoropropylvinylether; tetrafluoroethylene; hexafluoropropylene; vinylidenefluorochloride; trifluoroethylenechloride; vinylfluororide and 2-bromo-1,1,2,2-tetrafluoroethyltrifluorovinylether.

20. The proton exchange membrane fuel cell according to claim 11, wherein the electrolyte membrane includes a perfluorinated membrane or a hydrocarbon membrane.
